(19) United States
(12) Patent Application Publication
(10) Pub. No.: US 2020/0398171 A1
(43) Pub. Date: Dec. 24, 2020

(54) Display Mount for a Game Controller

(71) Applicant: Google LLC, Mountain View, CA (US)

(72) Inventors: John Thomas McDole, Sunnyvale, CA (US); Yu Bai, Sunnyvale, CA (US); Nicole Laferriere, Half Moon Bay, CA (US); Thomas Franz Enders, Mountain View, CA (US)

(73) Assignee: Google LLC, Mountain View, CA (US)

(21) Appl. No.: 16/733,747

(22) Filed: Jan. 3, 2020

Related U.S. Application Data
(63) Continuation of application No. 16/687,177, filed on Nov. 18, 2019.
(60) Provisional application No. 62/863,801, filed on Jun. 19, 2019.

(51) Int. Cl. A63F 13/98; A63F 13/26; A63F 13/92

(52) U.S. Cl. CPC A63F 13/98; A63F 13/92; A63F 13/26

(57) ABSTRACT

This document describes devices and systems related to gaming-systems and gaming-system accessories. In an aspect, a display mount for mounting a mobile device having a display and a housing on a game controller is described. The display mount includes a mobile device holder configured for releasable connection to the mobile device, a controller receiver configured for releasable connection with the game controller, and an upright for spacing the mobile device holder apart from the controller receiver.

### PRIORITY/CROSS-REFERENCE TO RELATED APPLICATIONS

This application is a continuation application of U.S. application Ser. No. 16/687,177, filed Nov. 18, 2019, which claims the benefit of U.S. Provisional Application No. 62/863,801, filed Jun. 19, 2019, the disclosures of which are incorporated by reference.

### BACKGROUND

Millions of people play video games on their mobile devices (e.g., smartphones). Typically, such mobile devices have touch-enabled screens (touch screens) and touch controls, which are used by a user to provide input to the mobile device. For example, a touch interface can be provided for a directional pad (D-pad) on a lower left side of the touch screen and for user action buttons (e.g., a jump button) on a lower right side of the touch screen.

There are many disadvantages to utilizing a touch interface to play a game on a mobile device. A first disadvantage is that the user may be accustomed to using a video game controller (controller) for playing games, and learning touch controls can be difficult and frustrating for the user. A second disadvantage is that users typically find touch interface controls to be less accurate than using a controller, detracting from the performance of the user when gaming A third disadvantage is that in playing a game using a touch interface, the user's fingers and/or thumbs may block the user's view of a portion of the display screen of the mobile device.

Because of these disadvantages, many users utilize a separate controller for providing input when playing mobile device games. Such a controller may connect to the mobile device via a wired interface (e.g., one or more wires) and/or a wireless interface (e.g., a Bluetooth™ connection, WLAN connection). The controller may include control interfaces (e.g., push buttons, trigger buttons, bump switches, directional switches, joysticks) that provide inputs to the mobile device. For example, a user may use a joystick on a controller to cause an animated character in a video game application running on the mobile device to move in various directions.

Typically, game controllers are configured for dual-handed use, with a user grasping the controller in both hands, with the user's left fingers and thumb operating controls on the left side of the controller and the user's right fingers and thumb operating controls on the right side of the controller. Due to the dual-handed nature of controllers, a user is typically not able to hold the mobile device in one hand and fully operate the controller with the other hand Instead, to utilize the display of the mobile device with such a controller, a user typically needs to place their mobile device in a stand resting upon a surface or may need to prop up their mobile device on a surface in order to conveniently present the mobile device's display screen to the user. Often, this process can result in a less-than-optimum game-play experience for the user and limits the mobility of the user while gaming.

### SUMMARY

This summary is provided to introduce devices and systems related to gaming-systems and gaming-system accessories. Aspects include display mounts for releasably mounting a mobile device having a display on a game controller (controller). The simplified concepts are further described below in the Detailed Description. This summary is not intended to identify essential features of the claimed subject matter, nor is it intended for use in determining the scope of the claimed subject matter.

One general aspect includes a display mount used to releasably mount a mobile device on a game controller. The mobile device has a display and a housing. The display mount includes a mobile device holder, a controller receiver, and an upright that extends between the mobile device holder and the controller receiver. The mobile device holder includes a body portion and a carriage portion. The body portion includes a top side opposite a bottom side; the top side defines a first platform configured to support a first back portion of the mobile device housing. The carriage portion has an upper side that defines a second platform configured to support a second back portion of the mobile device housing. At least one of the first platform or the second platform define a mobile device plane. The body portion includes a front clamping jaw configured to engage with a first side portion of the mobile device housing, and the carriage portion includes a rear clamping jaw configured to engage with a second side of the mobile device housing. The carriage portion is slidably connected to the body portion.

The controller receiver includes a frame portion, a front arm, and a rear arm. The frame portion defines a controller plane. The front arm extends from the first side of the frame portion, and the front arm is configured to engage with a first portion of the game controller. The rear arm extends from a second side of the frame portion and is configured to engage a second portion of the game controller. The front and rear arms are configured to clamp the controller receiver onto the game controller.

The upright is configured to space the mobile device holder apart from the controller receiver, for example, over and apart from the controller receiver. The upright includes a top-end that connects to the mobile device holder at the bottom side and a bottom end that connects to the controller receiver at the frame portion.

In aspects, the upright is positioned between the mobile device holder and the controller receiver to orient the mobile device plane defined by at least one of the first platform or the second platform at a 10-degree to 30-degree angle relative to the controller plane defined by the frame portion. In some aspects, the upright is positioned between the mobile device holder and the controller receiver to position the mobile device vertically over the controller when the mobile device is installed on the display mount. In some aspects, the upright is positioned between the mobile device holder and the controller receiver to locate a center-of-mass of the mobile device vertically centered over a center-of-mass of the controller when the display mount is installed on the mobile device and on the controller, with the controller is positioned for use by a user. In other aspects, the upright is positioned between the mobile device holder and the controller receiver to orient the mobile device plane defined by at least one of the first platform or the second platform at a 10-degree to 30-degree angle relative to the controller plane defined by the frame portion and to locate a center-of-mass of the mobile device vertically centered over a center-of-mass of the controller.

In another aspect, described is a display mount for mounting a mobile device having a display and a housing on a game controller. The display mount includes a mobile device holder configured for releasable connection to the mobile device, a controller receiver configured for releasable connection with the game controller, and an upright for spacing the mobile device holder over and apart from the controller receiver. The mobile device holder has a body portion and a carriage portion. The body portion has a front clamping jaw configured to engage a first side portion of the mobile device housing, and the carriage portion has a rear clamping jaw configured to engage a second side portion of the mobile device housing. The controller receiver includes a frame portion, a front arm that extends from a first side of the frame portion, and a rear arm that extends from a second side of the frame portion. The front arm configured to engage a first portion of the game controller. The rear arm configured to engage a second portion of the game controller. At least one of the front arm or the rear arm is configured for clamping the controller receiver onto the game controller. The upright includes a top-end that connects the mobile device holder at a bottom side of the body portion and a bottom end that connects to the controller receiver at the frame portion.

The details of one or more aspects of devices and systems related to gaming-systems and gaming-system accessories are set forth in the accompanying drawings and the following description. Other features and advantages will be apparent from the description and drawings, and from the claims. This Summary is provided to introduce subject matter that is further described in the Detailed Description and Drawings. Accordingly, this Summary should not be considered to describe essential features nor used to limit the scope of the claimed subject matter.

### BRIEF DESCRIPTION OF THE DRAWINGS

The details of one or more aspects of devices and systems related to gaming-systems and gaming-system accessories are described with reference to the following drawings. The use of the same reference numbers in different instances in the description and the figures may indicate like elements:

FIG. 1 is a front-side perspective view of a gaming-system including a display mount;

FIG. 2 is a left side, elevation view of the gaming-system, including a display mount of FIG. 1;

FIG. 3A is a first enlarged detail view of a portion of FIG. 2;

FIG. 3B is a second enlarged detail view of a portion of FIG. 2;

FIG. 4 is a schematic illustration of the gaming-system, including a display mount of FIG. 2;

FIG. 5A is a perspective view of the display mount of FIG. 1, illustrating the carriage of the mobile device holder in an extended position;

FIG. 5B is a perspective view of the display mount of FIG. 1, illustrating the carriage of the mobile device holder in a retracted position;

FIG. 6A is a left side view of the display mount of FIG. 1, illustrating the carriage of the mobile device holder in an extended position; and

FIG. 6B is a left side view of the display mount of FIG. 1, illustrating the carriage of the mobile device holder in a retracted position.

### DETAILED DESCRIPTION

This document describes one or more aspects of devices and systems related to gaming-systems and gaming-system accessories. Some aspects describe a gaming-system that includes a mobile device that has a display, a game controller (controller), and a display mount (e.g., a game-controller accessory) configured to releasably mount the mobile device on the controller. Other aspects describe a gaming-system that includes a controller in combination with a display mount configured to releasably mount a mobile device having a display on the controller. Still, other aspects describe a gaming-system accessory that has a display mount configured to releasably mount a mobile device having a display on a controller. In some aspects, a gaming-system includes, in combination, a mobile device and a display mount. In other aspects, a gaming-system includes, in combination, a mobile device, a display mount, and a game controller. In further aspects, a gaming-system includes, in combination, a display mount and a game controller.

The described gaming-systems and gaming-system accessories allow a user to comfortably use a game controller with a mobile device, regardless of whether the user is standing, sitting, or walking. For example, by utilizing a display mount to space the mobile device apart from the controller, the display of the mobile device is conveniently presented to the user when the user holds the controller in their hands, and the mobile device is positioned to not interfere with the thumbs of the user when using the controller (e.g., when using the analog sticks of the controller).

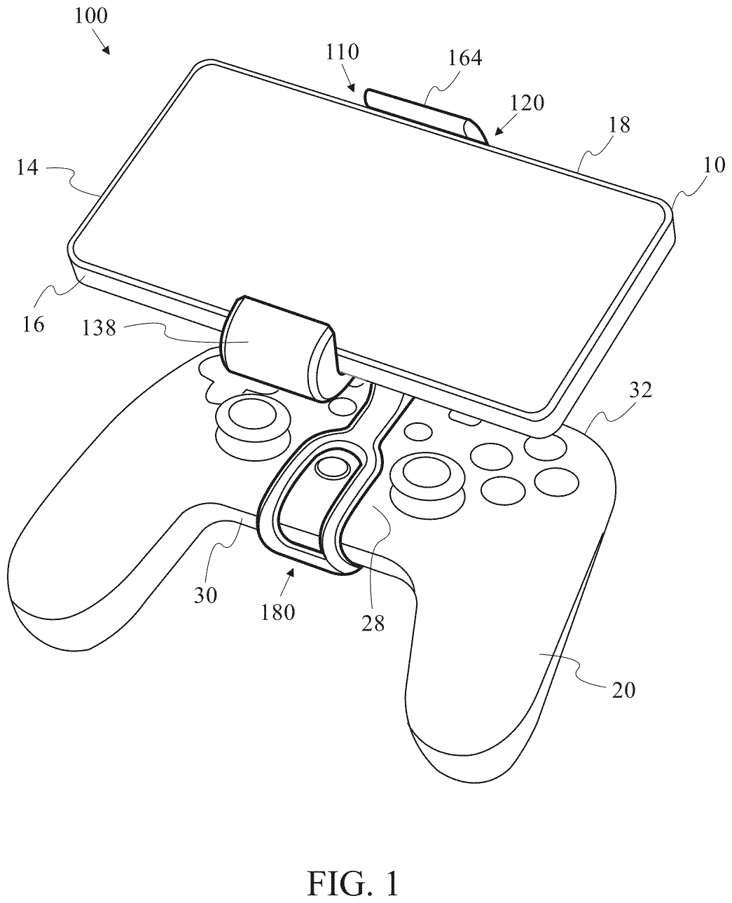

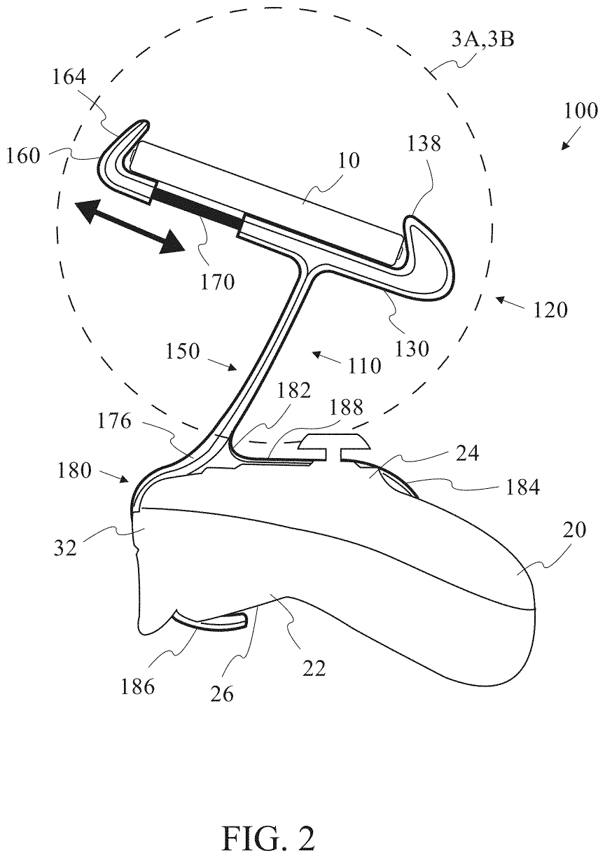

FIGS. 1, 2, 3A, 3B, and 4 illustrate a gaming-system 100 that includes a mobile device 10, a controller 20, and a display mount 110. In the gaming-system 100, the display mount 110 is configured to hold the mobile device 10 spaced apart from the controller 20. In FIGS. 1, 2, 3A, 3B, and 4, the mobile device 10 is illustrated as having a display 12 and a housing 14, the housing 14 having a first side portion 116, a first side 16, a first side upper corner 36, a first side lower corner 37, a housing back 17, a second side portion 118, a second side upper corner 38, a second side lower corner 39, and a second side 18. The first and second sides define a width therebetween. In aspects, the first side 16 and the second side 18 are generally perpendicular to the display 12, and the housing back 17 is generally parallel to the display 12. The mobile device 10 connects with the controller 20 through a wireless connection (e.g., Bluetooth, Wireless Local Area Network (WLAN)) or through a wired connection (e.g., one or more wires).

While the mobile device 10 is illustrated in FIGS. 1, 2, 3A, 3B, and 4 as a smartphone, mobile device 10 may be another type of mobile device. The term “mobile device,” as used in this disclosure, refers to a portable computing device with a display, unless the context clearly dictates otherwise. Examples of mobile devices include, but are not limited to, smartphones, tablet computers, wearable devices, handheld gaming devices, entertainment systems, video game consoles, display devices, mobile internet devices, portable media players, personal navigation devices, and the like. The term “wearable device,” as used in this disclosure, refers to any device that is capable of being worn at, on or in proximity to a person's body, such as a wrist, ankle, waist, chest, or other body part or prosthetic (e.g., watch, bracelet, ring, necklace, other jewelry, eyewear, footwear, glove, headwear, clothing, goggles, contact lens), unless the context clearly dictates otherwise.

The controller 20 illustrated in FIGS. 1, 2, and 4 is a gamepad configured for being held in both hands of a user, with a user's thumbs and fingers used to provide input via one or more buttons, joysticks, directional pads, control pads, triggers, shoulder buttons (bumpers), and the like. While the controller 20 is illustrated in FIGS. 1, 2, and 4 as a gamepad, the controller 20 may be another type of controller. The terms “game controller” and “controller,” as used in this disclosure, refer to an input device used to provide input to a mobile device, unless the context clearly dictates otherwise. Examples of game controllers include, but are not limited to, gamepads, joysticks, mice, keyboards, touchscreens, motion controllers, and the like. In aspects, a game controller may be an input device used to control an object or character in a game running on a mobile device.

The display mount 110 is utilized to hold the mobile device 10 spaced apart from the controller 20. In such a configuration, the display 12 of the mobile device 10 faces the user when the user holds the controller 20 in their hands. Further, the mobile device 10 is positioned relative to the controller 20 so as not to interfere with the user's operation of the controller 20. For example, in aspects, the mobile device 10 is positioned by the display mount 110 so that the mobile device 10 does not contact the thumbs of the user when the user is using the controller 20 (e.g., the analog sticks of the controller 20).

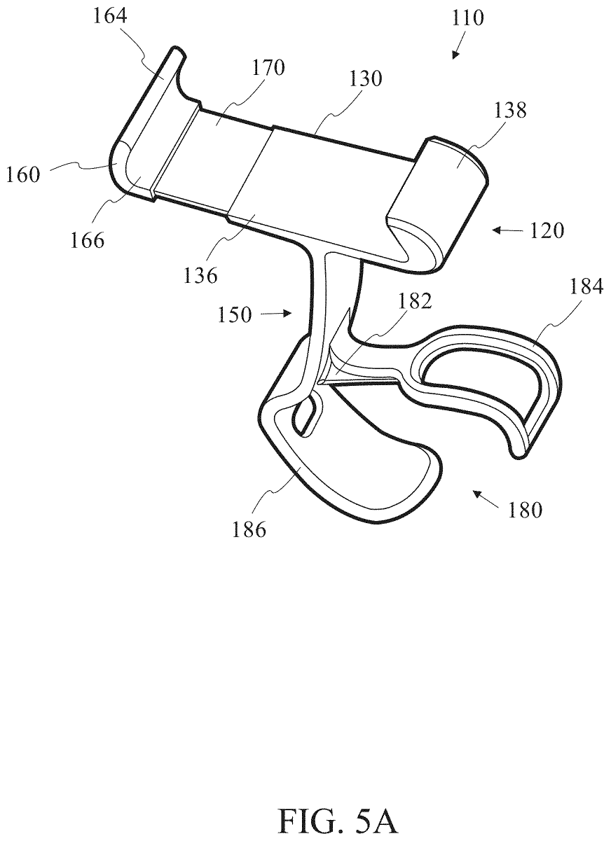

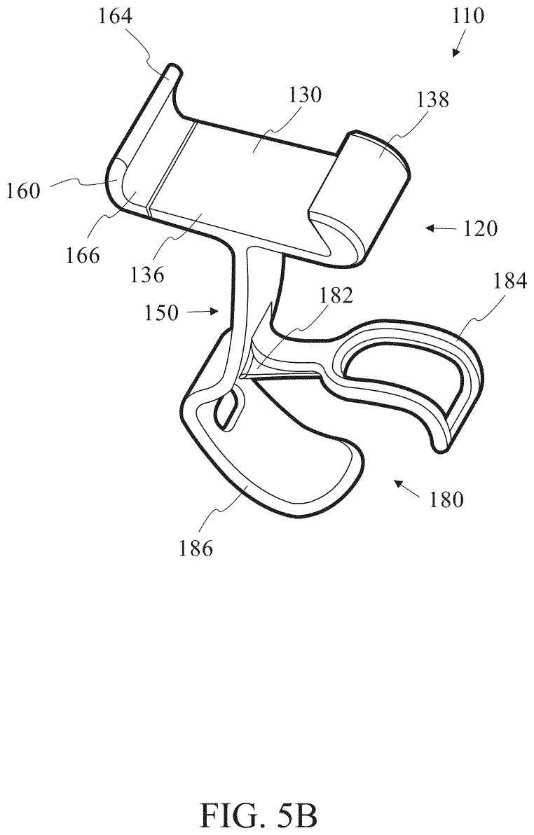

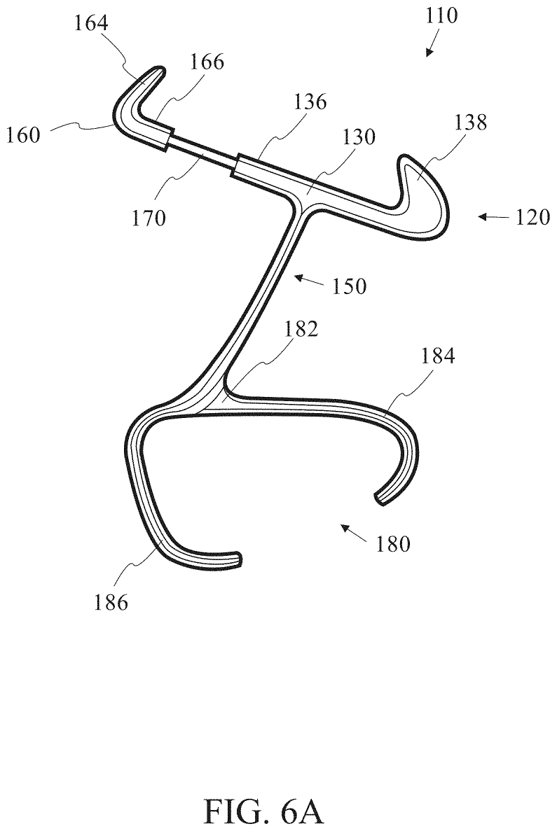

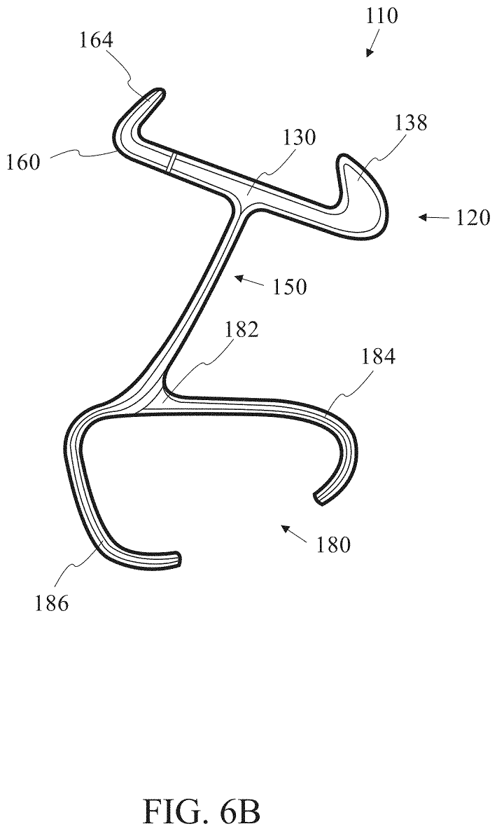

The display mount 110 illustrated in FIGS. 1, 2, 3A, 3B, and 4 is further illustrated in FIGS. 5A, 5B, 6A, and 6B. The display mount 110 has a mobile device holder 120, an upright 150, and a controller receiver 180. The mobile device holder 120 of the display mount 110 is configured for releasable connection to the mobile device 10. In the aspects illustrated in FIGS. 1-10, the mobile device holder 120 has a body portion 130 and a carriage portion 160. In aspects, the body portion 130 is slidably connected to the carriage portion 160 so that the carriage portion 160 can slide away from the body portion 130 to an extended position and slide towards the body portion 130 to a retracted position.

Through this slidable connection, the mobile device holder 120 can be releasably connected to the mobile device 10. The body portion 130 includes a front clamping jaw 138, and the carriage portion 160 includes a rear clamping jaw 164. The front clamping jaw 138 is configured to engage a first side portion 116 of the housing 14 (e.g., at least one of the first side 16 of the housing 14 of the mobile device 10 or the corner 36 between the first side 16 of the housing 14 of the mobile device 10 and the display 12), and the rear clamping jaw 164 is configured to engage a second side portion 118 of the housing 14 (e.g., at least one of the second side 18 of the housing 14 of the mobile device 10 or the corner 38 between the second side 18 of the housing 14 of the mobile device 10 and the display 12). Through such engagement, the front clamping jaw 138 and the rear clamping jaw 164 cooperate to hold the mobile device 10 within the mobile device holder 120.

In aspects, the front clamping jaw 138 and the rear clamping jaw 164 define confronting surfaces configured to respectively engage at least one of the first side portion 116 of the housing 14 or the second side portion 118 of the housing 14. Through such engagement, the front clamping jaw 138 and the rear clamping jaw 164 cooperate to hold the mobile device 10 within the mobile device holder 120. In an example, the front clamping jaw 138 defines a front confronting surface 139, and the rear clamping jaw 164 defines a rear confronting surface 167. One or more of the front confronting surface 139 of the front clamping jaw 138 or the rear confronting surface 167 of the rear clamping jaw 164 may define at least one pocket configured to receive therein one or more sides of the mobile device 10. For example, one or more of the front confronting surface 139 of the front clamping jaw 138 or the rear confronting surface 167 of the rear clamping jaw 164 may be curved to define at least one pocket configured to receive therein one or more sides of the mobile device 10. In such a configuration, one or more mobile device buttons (e.g., squeeze sensor, power button, volume up/down button, or another side-carried button) on one or more of the sides of the mobile device 10 may be received in one or more pockets, and the receipt of the mobile device holder on the mobile device does not actuate such mobile device button(s).

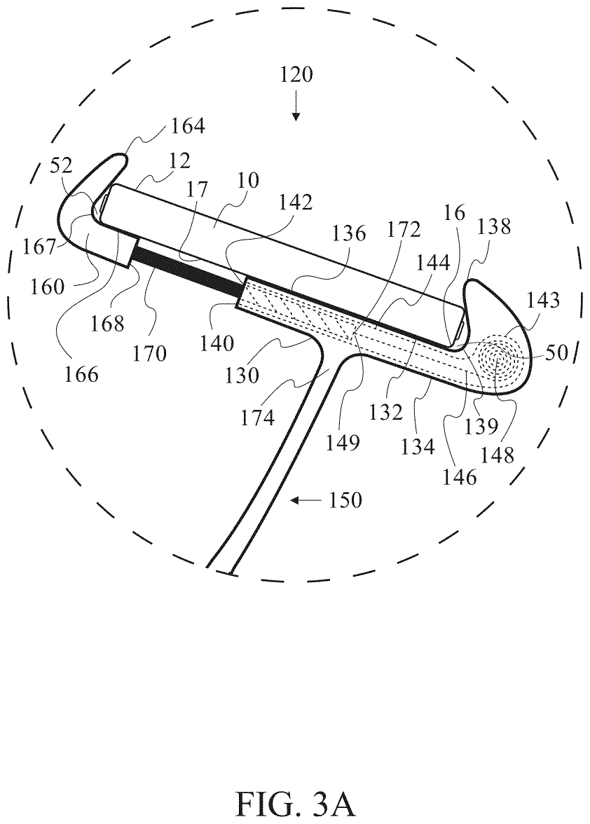

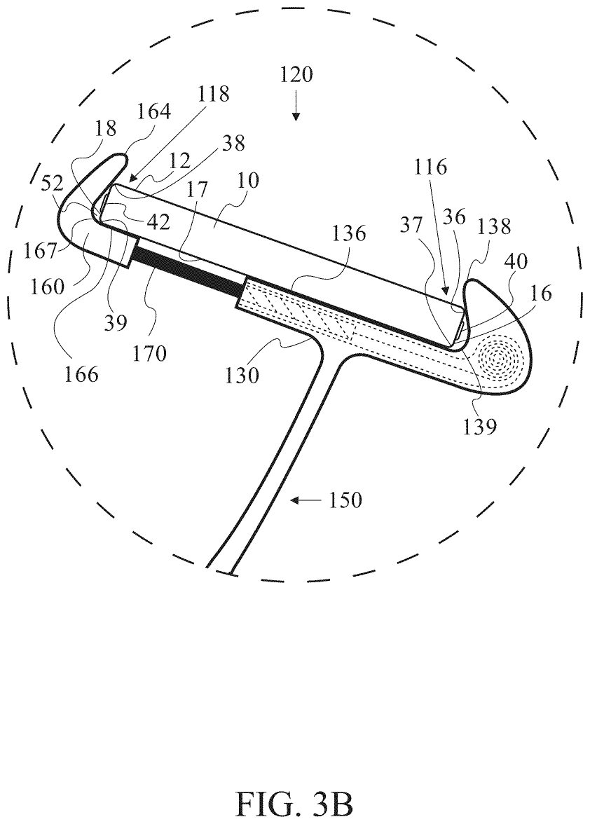

For example, as illustrated in FIG. 3A, the front confronting surface 139 of the front clamping jaw 138 is concave in shape, defining a pocket 50 configured to receive therein the first side 16 of the mobile device 10. In such a configuration, the front confronting surface 139 of the front clamping jaw 138 does not engage the first side 16 of the mobile device 10. As a result, the front confronting surface 139 of the front clamping jaw 138 would not actuate a component (e.g., a button, a squeeze sensor) on the first side 16 of the mobile device 10. In a further example, as illustrated in FIG. 3A, the rear confronting surface 167 of the rear clamping jaw 164 is concave in shape, defining a pocket 52 configured to receive therein the second side 18 of the mobile device 10. In such a configuration, the rear confronting surface 167 of the rear clamping jaw 164 does not engage the second side 18 of the mobile device 10. As a result, the rear confronting surface 167 of the rear clamping jaw 164 would not actuate a component (e.g., a button, a squeeze sensor) on the second side 18 of the mobile device 10.

One or more of the front confronting surface 139 of the front clamping jaw 138 or the rear confronting surface 167 of the rear clamping jaw 164 may be curved to define at least one pocket configured to receive therein one or more mobile device buttons (e.g., squeeze sensor, power button, volume up/down button, or other side-carried button) on one or more of the sides of the mobile device therein, so that the display mount 110, when installed on a mobile device 10, does not depress the mobile device button(s). In an example, the front clamping jaw 138 is curved to define a first pocket 50 configured to receive at least one first mobile device button 40 located on the first side 16 of the mobile device 10, so that the front clamping jaw 138, when the mobile device holder 120 is installed on the mobile device 10, avoids the first mobile device button 40. In another example, the rear clamping jaw 164 is curved to define a second pocket 52 configured to receive at least one second mobile device button 42 located on the second side 18 of the mobile device 10, so that rear clamping jaw 164, when the mobile device holder 120 is installed on the mobile device 10, avoids the second mobile device button 42. In a further example, illustrated in FIG. 3A, the front clamping jaw 138 is curved to define a first pocket 50 configured to receive at least one first mobile device button 40 located on the first side 16 of the mobile device 10 and the rear clamping jaw 164 is curved to define a second pocket 52 configured to receive at least one second mobile device button 42 located on a second side 18 of the mobile device 10, so that the front clamping jaw 138 and the rear clamping jaw 164, when the mobile device holder 120 is installed on a mobile device 10, respectively avoid the first mobile device button(s) 40 and the second mobile device button(s) 42.

In some aspects, at least one of the clamping jaws is configured to move away from the other clamping jaw. For example, in the aspects illustrated in FIGS. 1-10, the front clamping jaw 138 and the rear clamping jaw 164 are slidably connected to one another, and the rear clamping jaw 164 is configured to move away from the front clamping jaw 138. FIGS. 1-4, 5A, and 6A illustrate an extended position where front clamping jaw 138 is spaced apart from the rear clamping jaw 164, and the clamping jaws together hold the width of the mobile device 10 therebetween. In aspects, the front clamping jaw 138 can be further spaced apart from the rear clamping jaw 164 in a fully extended position (not illustrated), where the two clamping jaws are spaced apart farther than the width of the mobile device 10, so as to facilitate the insertion of the width of the mobile device 10 therebetween. FIGS. 5B and 6B illustrate the carriage portion 160 of the mobile device holder 120 in a fully retracted position relative to the body portion 130, where the carriage portion 160 is adjacent to the body portion 130. In such a configuration, the front clamping jaw 138 is relatively near the rear clamping jaw 164, in comparison to the extended position.

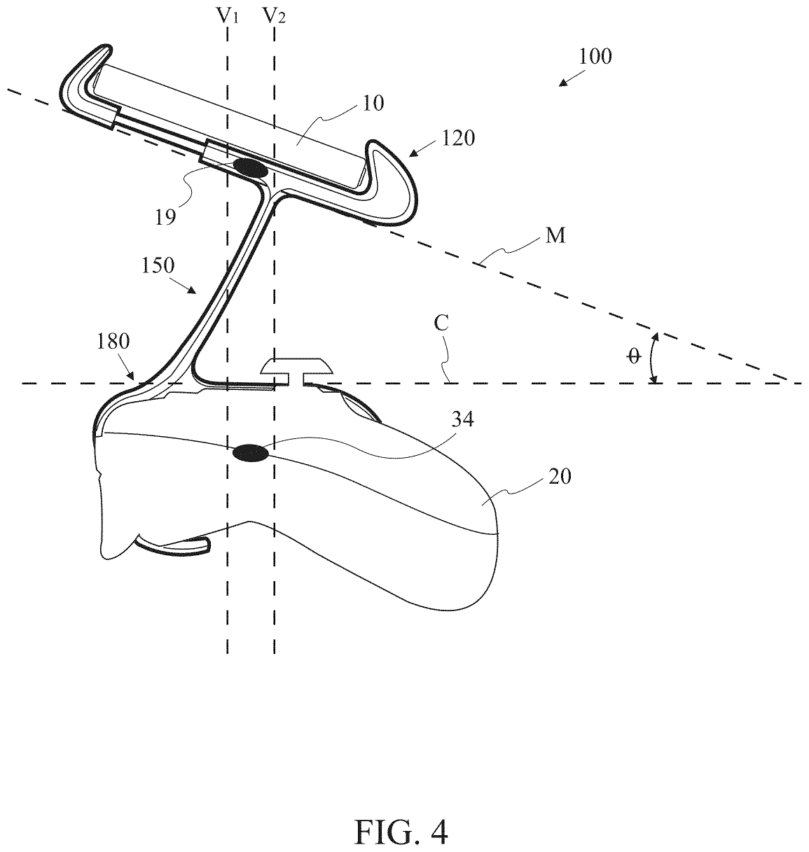

The body portion 130 has a top side 132 opposite a bottom side 134. The bottom side 134 of the body portion 130 connects with the top-end 174 of the upright 150. The top side 132 defines a first platform 136 configured to support a first back portion of the housing 14 of the mobile device 10 thereon. The carriage portion 160 has an upper side 165 that defines a second platform 166 configured to support a second back portion of the housing 14 of the mobile device 10 thereon. In aspects, the first platform 136 and the second platform 166 are generally co-planar in the extended and retracted positions. In other aspects, the first platform 136 and the second platform 166 are not co-planar. In aspects, the first platform 136 is configured to support a left side of the housing 14, and the second platform 166 is configured to support the right side of the housing 14. At least one of the first platform 136 or the second platform 166 define a mobile device plane M, illustrated in FIG. 4. In aspects, when a mobile device 10 is held in the mobile device holder 120, a plane of the display 12 (and/or a plane of the housing 14) of the mobile device 10 will generally be parallel to the mobile device plane M.

The carriage portion 160 has a mounting assembly 168 configured for slidably connecting the carriage portion 160 to the body portion 130. The carriage portion 160 includes at least one guide 170 extending from the mounting assembly 168. In the aspect illustrated in the Figures, the guide 170 is illustrated as a flange. In other aspects, the guide 170 may include one or more rods extending from the mounting assembly 168.

The body portion 130 includes a dock 140. At least one guide channel 144 is defined within the body portion 130, extending into the body portion 130 from an orifice 142 defined the dock 140. The guide channel 144 is configured for slidably receiving the guide 170 of the carriage portion 160 therein. In the aspect illustrated in the Figures, the guide channel 144 is illustrated as a slot defined in the body portion 130. In other aspects, the guide channel 144 may include one or more passageways extending into the body portion 130 from one or more orifices 142 defined in the dock 140. For example, in an aspect where the guide 170 includes two rods extending from the mounting assembly, the guide channel 144 may include two passageways extending into the body portion 130, each passageway extending into the body portion 130 from an orifice 142 defined in the dock 140.

The carriage portion 160 is movable relative to the body portion 130, from a partially retracted position (illustrated in FIGS. 1-4) where the front clamping jaw 138 and the rear clamping jaw 164 respectively engage the first side 16 and second side 18 of the housing 14 of the mobile device 10, to an extended position where at least one of the front clamping jaw 138 or the rear clamping jaw 164 is disengaged from the respective first or second sides of the mobile device 10.

At least one of the body portion 130 and the carriage portion 160 is biased towards the other or both the body portion 130 and the carriage portion 160 are biased towards each other. In aspects, the mobile device holder 120 includes at least one biasing means 146 for biasing at least one of the clamping jaws towards the other clamping jaw, for example, biasing the rear clamping jaw 164 towards the front clamping jaw 138. Examples of biasing means include, but are not limited to, one or more springs (e.g., extension spring, tension spring, coil spring, torsion spring, constant-force spring), elastic members (e.g., rubber band, elastic band), and the like. In the mobile device holder 120 illustrated in FIGS. 3A and 3B, the biasing means 146 is a spring. The term “biasing means,” as used in this disclosure, refers to any component that is provided for exerting a force on a component and/or components to ensure that the component and/or components are forced together (e.g., into engagement) or forced apart (e.g., out of engagement). Through the use of a biasing means 146, the mobile device holder 120 is adjustable and able to be utilized with multiple different makes and models of mobile devices 10. In other aspects, the front clamping jaw 138 and the rear clamping jaw 164 are positioned relative to one another (e.g., forced together, forced apart) through the use of other mechanical connections (e.g., ratcheting connections, one-way click/cam mechanisms, clamping connections), friction fits, interference fits, and the like. In aspects, the relative positioning is releasable so that a mobile device 10 held in the mobile device holder 120 may be released from the connection and removed from the display mount 110.

The biasing means 146 illustrated in FIGS. 3A and 3B is a tension spring (e.g., a constant-force spring) having a first end 148 attaching to the body portion 130. In aspects, the first end 148 attaches to the body portion 130 within a recess 143 defined within the body portion 130, the recess 143 connecting with the guide channel 144. In aspects, at least a portion of the biasing means 146 is received within the guide channel 144. The biasing means 146 further has a second end 149 attaching at the front end 172 of the guide 170 of the carriage portion 160. In such an arrangement, the biasing means 146 spring-biases the carriage portion 160 towards the body portion 130.

FIG. 1 further illustrates the controller receiver 180 connected to the upright 150 at a bottom end 176 of the upright 150. The controller receiver 180 configured for releasable connection with the game controller 20. The controller receiver 180 includes a frame portion 182, a front arm 184, and a rear arm 186. The frame portion 182 having a width that defines a controller plane C configured to generally extend parallel to a control surface 24 of the controller 20 when the controller receiver 180 is installed on a controller 20. For example, the controller plane C may extend generally parallel to a top side 28 of the controller 20. A top side 28 of a controller 20 may define a control surface 24 having one or more buttons, joysticks, directional pads, or control pads. In aspects, the control surface 24 is generally perpendicular to an axis of one or more control sticks located on the controller 20.

The front arm 184 extends from a first side 188 of the frame portion 182, and the rear arm 186 extends from a second side 190 of the frame portion 182. The front arm 184 configured to engage a first portion (e.g., the front side 30) of the game controller 20 and the rear arm 186 configured to engage a second portion (e.g., the backside 32) of the game controller 20. The front and rear arms are configured for releasably connecting the controller receiver 180 to the game controller 20. In aspects, the releasable connection with the game controller 20 is an interference fit formed by the front aim 184 wrapping around the first portion (e.g., the front side 30) of the game controller 20 and the rear arm 186 wrapping around a second portion (e.g., the backside 32) of the game controller 20. In other aspects, the front arm 184 is biased relative to the rear arm 186, enabling the housing 22 of the game controller 20 to be releasably held therebetween. For example, the front arm 184, rear arm 186, and frame portion 182 may be molded together to define a shape configured for snapping onto a portion of the housing 22 of a game controller 20. In such a configuration, at least one of the front arm 184, rear arm 186, or the frame portion 182 may be flexible and able to be bent so that the controller receiver 180 can be snapped onto the controller 20. In aspects, the front arm 184 is configured to wrap around a front side 30 of the controller 20, and the rear arm 186 is configured to wrap around a backside 32 of the controller 20. In aspects, the controller receiver 180 is configured to hold the game controller 20 tightly so that the display mount 110 and the attached mobile device 10 remain attached to the game controller 20 during use (e.g., when the user is walking while playing).

The upright 150 connects the mobile device holder 120 to the controller receiver 180. The upright 150 is configured to space the mobile device holder 120 apart from the controller receiver 180. The upright 150 includes a top-end 174 that connects the body portion 130 of the mobile device holder 120 at the bottom side 134 and a bottom end 176 that connects to the controller receiver 180 at the frame portion 182.

In aspects, one or more portions (e.g., the front clamping jaw, the rear clamping jaw, the first platform, the second platform, the frame, the front arm, the rear arm) of the display mount 110 may include a cushion portion (e.g., padding) for supporting the connection of the display mount 110 on at least one of the mobile device 10 or the controller 20. A cushion portion may also be used to protect the surface finish of the mobile device 10 and/or controller 20. For example, the front clamping jaw 138 and the rear clamping jaw 164 include one or more cushion portions for protecting the mobile device 10, and the front arm 184 and rear arm 186 may include one or more cushion portions for protecting the surface of the controller 20. The cushion portion may include an s-molded portion (e.g., silicon over-mold, rubber over-mold) applied to one or more surfaces of the display mount 110. In aspects, a cushion portion may be received into a recess defined in a surface of the display mount 110.

As discussed above, the first platform 136 and the second platform 166 define a mobile device plane M. In aspects, when mobile device 10 is held in the mobile device holder 120, at least one of a plane of the display 12 or a plane of the housing 14 of the mobile device 10 will be generally parallel to the mobile device plane M. Further, the frame portion 182 has a width that defines a controller plane C, generally extending parallel to a control surface 24 of the controller 20. In FIG. 4, the angle defining the relationship of the mobile device plane M to the controller plane C is labeled with the Greek letter theta (Θ). In aspects, the upright 150 is positioned between the mobile device holder 120 and the controller receiver 180 so as to orient the mobile device plane M at a 10-degree to 30-degree angle relative to the controller plane C (e.g., Θ=10-30 degrees). In some aspects, the upright 150 is positioned between the mobile device holder 120 and the controller receiver 180 so as to orient the mobile device plane M at a 24-degree to 25-degree angle relative to the controller plane C (e.g., Θ=24 to 25 degrees). By so positioning mobile device plane M relative to the controller plane C, the mobile device 10 can be positioned comfortably for the user, with the display 12 of the mobile device 10 facing the user and generally oriented perpendicular to a line of sight of the user.

The mobile device 10 has a center-of-mass that is typically located near the center of the mobile device 10. As the mobile device 10 is tilted respective to an axis, for example, as illustrated in FIGS. 1-4, the center-of-mass likewise shifts. FIG. 4 illustrates a general center-of-mass 19 for the mobile device 10. The controller 20 has a center-of-mass that is typically located near the center of the body of the controller 20. FIG. 4 also illustrates a general center-of-mass 34 for the controller 20. Typically, the center-of-mass of a controller is located near the center of the housing 22. In aspects, as illustrated in FIG. 4, the display mount 110 is configured to position the mobile device 10 held in the mobile device holder 120 generally over the controller 20 held in the controller receiver 180. In aspects, as illustrated in FIG. 4, the display mount 110 is configured to position the center-of-mass 19 of the mobile device 10 held in the mobile device holder 120 generally relative to the center-of-mass 34 of a controller 20 held in the controller receiver 180. In other aspects, the upright 150 is positioned between the mobile device holder 120 and the controller receiver 180 to generally locate the center-of-mass 19 of the mobile device 10 generally vertically centered over the center-of-mass 34 of the controller 20 when the display mount 110 is installed on the mobile device 10 and on the controller 20, with the controller 20 positioned for use by a user (e.g., held by the user in the user's hands). Vertical axis V1 and vertical axis V2 are illustrated in FIG. 4 for helping illustrate that the center-of-mass 19 of the mobile device 10 is generally located vertically centered over the center-of-mass 34 of the controller 20.

In some aspects, the upright 150 is positioned between the mobile device holder 120 and the controller receiver 180 so as to orient the mobile device plane M at a 10-degree to 30-degree angle relative to the controller plane C and to generally locate a center-of-mass 19 of the mobile device 10 vertically centered over a center-of-mass 34 of the controller 20. For example, the center-of-mass 19 of the mobile device 10 could be positioned vertically centered over a center button on the control surface 24 of the controller 20. By orienting the center-of-mass 19 of the mobile device 10 vertically centered over the center-of-mass 34 of the controller 20, the gaming-system 100 feels well balanced to the user.

In aspects, the configuration provided by the described gaming-system results in locating the center-of-mass of the mobile device generally vertically centered over the center-of-mass of the game controller. Through such a configuration, the center-of-mass for the gaming-system (e.g., mobile device, display mount, game controller) is located adjacent the location of the user's thumbs when operating the game controller (e.g., adjacent a center button of the game controller), resulting in a balanced gaming-system. If the center-of-mass of the gaming-system is located forward (towards the user), the gaming-system may feel front heavy, and the user may need to flex their wrists forward to better position the screen in their line of sight. If the center-of-mass of the gaming-system is located backward (away from the user), the gaming-system may feel rear heavy, and the user may need to extend their wrists rearwards to better position the screen in their line of sight.

To install the display mount 110 illustrated in FIGS. 1-4 on a mobile device 10, a user would apply a manual force to the rear clamping jaw 164 to overcome the biasing force of the biasing means (e.g., spring), enabling the rear clamping jaw 164 to be moved away from the front clamping jaw 138. Upon separating the front and rear clamping jaws, the user can insert a mobile device 10 therebetween. Upon releasing the manual force applied by the user, the rear clamping jaw 164 would be drawn towards the front clamping jaw 138 by the biasing force of the biasing means, holding the mobile device 10 within the mobile device holder 120.

For example, the user could apply a force by pressing the second side 18 of the housing 14 of the mobile device 10 against the rear clamping jaw 164, causing the rear clamping jaw 164 to move away from the front clamping jaw 138. Upon the front and rear clamping jaws being moved apart a distance greater than a width of the mobile device 10, an opposite second side 18 of the mobile device 10 could be lowered into the mobile device holder 120 adjacent the rear clamping jaw 164. Upon releasing the manual force, the rear clamping jaw 164 would be drawn towards the front clamping jaw 138 by the biasing force of the biasing means, holding the mobile device 10 within the mobile device holder 120, with the housing 14 of the mobile device 10 resting upon the first platform 136 and second platform 166 of the mobile device holder 120. The process would be reversed to remove the mobile device 10 from the mobile device holder 120.

To install the display mount 110 illustrated in FIGS. 1-4 on a controller 20, a user would position the front arm 184 of the controller receiver 180 against a first portion of the housing 22 of the controller 20 and wrap the rest of the controller receiver 180 around the housing 22, so that the rear arm 186 is positioned against a second portion of the housing 22. In such a configuration, the controller receiver 180 attaches to the controller 20 through a friction fit, with the frame portion 182 positioned adjacent to the control surface 24 of the controller 20. The process would be reversed to remove the controller 20 from the controller receiver 180.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

Although embodiments of devices and systems related to gaming-systems and gaming-system accessories have been described in language specific to features and/or methods, it is to be understood that the subject of the appended claims is not necessarily limited to the specific features or methods described. Rather, the specific features and methods are disclosed as example implementations of devices and systems related to gaming-systems and gaming-system accessories.

What is claimed is:

1. A display mount for mounting a mobile device having a display and a housing on a game controller, the display mount comprising:
a mobile device holder configured for releasable connection to the mobile device, the mobile device holder comprising:
a body portion, the body portion comprising a front clamping jaw configured for engaging a first side portion of the mobile device housing; and
a carriage portion, the carriage portion comprising a rear clamping jaw configured for engaging a second side portion of the mobile device housing;
a controller receiver configured for releasable connection with the game controller, the controller receiver comprising:
a frame portion;
a front aim extending from a first side of the frame portion, the front arm configured for engaging a first portion of the game controller; and
a rear arm extending from a second side of the frame portion, the rear arm configured for engaging a second portion of the game controller, at least one of the front arm or the rear arm configured for clamping the controller receiver onto the game controller; and
an upright for spacing the mobile device holder over and apart from the controller receiver, the upright comprising a top-end connecting the mobile device holder at a bottom side of the body portion and a bottom end connecting to the controller receiver at the frame portion.

2. The display mount of claim 1,
wherein the body portion further comprises a top side opposite the bottom side, the top side defining a first platform configured for supporting a first back portion of the mobile device housing;
wherein the carriage portion further comprises an upper side defining a second platform configured for supporting a second back portion of the mobile device housing;
wherein at least one of the first platform or the second platform define a mobile device plane;
wherein the frame portion defines a controller plane; and
wherein the upright is positioned between the mobile device holder and the controller receiver to orient the mobile device plane at a 10-degree to 30-degree angle relative to the controller plane.

3. The display mount of claim 2, wherein the upright is positioned between the mobile device holder and the controller receiver to orient the mobile device plane at a 10-degree to 30-degree angle relative to the controller plane and to locate a center-of-mass of the mobile device vertically centered over a center-of-mass of the game controller.

4. The display mount of claim 2, wherein the mobile device holder is configured to support at least one of the first back portion or the second back portion of the housing of the mobile device on at least one of the first platform or the second platform in an orientation where a plane of the display of the mobile device is generally parallel to the mobile device plane.

5. The display mount of claim 1, wherein the upright is positioned between the mobile device holder and the controller receiver to locate the mobile device vertically over the game controller when the display mount is installed on the mobile device and on the game controller, with the game controller is positioned for use.

6. The display mount of claim 1,
wherein the carriage portion comprises a mounting assembly configured for slidably mounting the carriage portion to the body portion;
wherein the carriage portion defines at least one guide extending from the mounting assembly;
wherein the body portion comprises a dock configured for slidably mounting to the mounting assembly of the carriage portion; and
wherein at least one guide channel is defined within the body portion, the guide channel extending into the body portion from an orifice defined in the dock, the guide channel configured for slidably receiving the guide of the carriage portion therein.

7. The display mount of claim 6, wherein the carriage portion is movable relative to the body portion from a retracted position where the front clamping jaw and the rear clamping jaw respectively engage the first side portion of the mobile device housing and the second side portion of the mobile device housing to an extended position where at least one of the front clamping jaw or the rear clamping jaw is disengaged from the respective first or second side portions of the mobile device.

8. The display mount of claim 1,
wherein the first side portion of the housing of the mobile device includes a first side of the housing, a first side upper corner of the housing, and a first side lower corner of the housing;
wherein the front clamping jaw defines a front confronting surface configured to engage the first side portion of the housing;
wherein the second side portion of the housing of the mobile device includes a second side of the housing, a second side upper corner of the housing, and a second side lower corner of the housing; and
wherein the rear clamping jaw defines a rear confronting surface configured to engage the second side portion of the housing.

9. The display mount of claim 8, wherein at least one of the front confronting surface or the rear confronting surface defines a pocket configured to receive therein a button of the mobile device, wherein in such a configuration, the button is not actuated by the receipt of the mobile device holder on the mobile device.

10. The display mount of claim 1, wherein the mobile device holder further comprises biasing means for biasing the rear clamping jaw towards the front clamping jaw.

11. A display mount for mounting a mobile device having a display and a housing on a game controller, the display mount comprising:
a mobile device holder configured for releasable connection to the mobile device, the mobile device holder comprising:
a body portion, the body portion comprising a front clamping jaw configured for engaging a first side portion of the mobile device housing,
wherein the first side portion of the housing of the mobile device includes a first side of the housing, a first side upper corner of the housing, and a first side lower corner of the housing; and
wherein the front clamping jaw defines a front confronting surface configured to engage at least one of the first side of the housing, first side upper corner of the housing, or the first side lower corner of the housing;
a carriage portion, the carriage portion comprising a rear clamping jaw configured for engaging a second side portion of the mobile device housing;
wherein the second side portion of the housing of the mobile device includes a second side of the housing, a second side upper corner of the housing, and a second side lower corner of the housing; and
wherein the rear clamping jaw defines a rear confronting surface configured to engage at least one of the second side of the housing, the second side upper corner of the housing, or the second side lower corner of the housing;
a controller receiver configured for releasable connection with the game controller, the controller receiver comprising:
a frame portion;
a front aim extending from a first side of the frame portion, the front arm configured for engaging a first portion of the game controller; and
a rear arm extending from a second side of the frame portion, the rear arm configured for engaging a second portion of the game controller, at least one of the front arm or the rear arm configured for clamping the controller receiver onto the game controller; and
an upright for spacing the mobile device holder over and apart from the controller receiver, the upright comprising a top-end connecting the mobile device holder at a bottom side of the body portion and a bottom end connecting to the controller receiver at the frame portion.

12. The display mount of claim 11, wherein at least one of the front confronting surface or the rear confronting surface defines a pocket configured to receive therein a button of the mobile device, wherein in such a configuration, the button is not actuated by the receipt of the mobile device holder on the mobile device.

13. The display mount of claim 11,
wherein the body portion further comprises a top side opposite the bottom side, the top side defining a first platform configured for supporting a first back portion of the mobile device housing;
wherein the carriage portion further comprises an upper side defining a second platform configured for supporting a second back portion of the mobile device housing;
wherein at least one of the first platform or the second platform define a mobile device plane;
wherein the frame portion defines a controller plane; and
wherein the upright is positioned between the mobile device holder and the controller receiver to orient the mobile device plane at a 10-degree to 30-degree angle relative to the controller plane.

14. The display mount of claim 13, wherein the upright is positioned between the mobile device holder and the controller receiver to orient the mobile device plane at a 10-degree to 30-degree angle relative to the controller plane and to locate a center-of-mass of the mobile device vertically centered over a center-of-mass of the game controller.

15. The display mount of claim 13, wherein the mobile device holder is configured to support at least one of the first back portion or the second back portion of the housing of the mobile device on at least one of the first platform or the second platform in an orientation where a plane of the display of the mobile device is generally parallel to the mobile device plane.

16. The display mount of claim 11, wherein the upright is positioned between the mobile device holder and the controller receiver to locate the mobile device vertically over the game controller when the display mount is installed on the mobile device and on the game controller, with the game controller is positioned for use by a user.

17. The display mount of claim 11,
wherein the carriage portion comprises a mounting assembly configured for slidably mounting the carriage portion to the body portion;
wherein the carriage portion defines at least one guide extending from the mounting assembly;
wherein the body portion comprises a dock configured for slidably mounting to the mounting assembly of the carriage portion; and
wherein at least one guide channel is defined within the body portion, the guide channel extending into the body portion from an orifice defined in the dock, the guide channel configured for slidably receiving the guide of the carriage portion therein.

18. The display mount of claim 17, wherein the carriage portion is movable relative to the body portion from a retracted position where the front clamping jaw and the rear clamping jaw respectively engage the first side portion of the mobile device housing and the second side portion of the mobile device housing to an extended position where at least one of the front clamping jaw or the rear clamping jaw is disengaged from the respective first or second side portions of the mobile device.

19. The display mount of claim 11, wherein the mobile device holder further comprises biasing means for biasing the rear clamping jaw towards the front clamping jaw.

20. A display mount for mounting a mobile device having a display and a housing on a game controller, the display mount comprising:
a mobile device holder configured for releasable connection to the mobile device, the mobile device holder comprising:
a body portion, the body portion comprising a front clamping jaw configured for engaging a first side portion of the mobile device housing,
wherein the first side portion of the housing of the mobile device includes a first side of the housing, a first side upper corner of the housing, and a first side lower corner of the housing; and
wherein the front clamping jaw defines a front confronting surface configured to engage at least one of the first side of the housing, first side upper corner of the housing, or the first side lower corner of the housing;
a carriage portion, the carriage portion comprising a rear clamping jaw configured for engaging a second side portion of the mobile device housing;
wherein the second side portion of the housing of the mobile device includes a second side of the housing, a second side upper corner of the housing, and a second side lower corner of the housing; and
wherein the rear clamping jaw defines a rear confronting surface configured to engage at least one of the second side of the housing, the second side upper corner of the housing, or the second side lower corner of the housing;
a controller receiver configured for releasable connection with the game controller, the controller receiver comprising:
a frame portion;
a front aim extending from a first side of the frame portion, the front arm configured for engaging a first portion of the game controller; and
a rear arm extending from a second side of the frame portion, the rear arm configured for engaging a second portion of the game controller, at least one of the front arm or the rear arm configured for clamping the controller receiver onto the game controller; and
an upright for spacing the mobile device holder apart from the controller receiver, the upright comprising a top-end connecting the mobile device holder at a bottom side of the body portion and a bottom end connecting to the controller receiver at the frame portion,
wherein at least one of the front confronting surface or the rear confronting surface defines a pocket configured to receive therein a button of the mobile device, wherein in such a configuration, the button is not actuated by the receipt of the mobile device holder on the mobile device.
